(19) United States
(12) Patent Application Publication
(10) Pub. No.: US 2026/0350765 A1
(43) Pub. Date: Nov. 5, 2026

(54) SYSTEM FOR IMAGE SUPER-RESOLUTION AND METHODS OF USE

(71) Applicant: Oceaneering International, Inc., Houston, TX (US)

(72) Inventors: Carl GILL, Millersville, MD (US); Sudheendra KRISHNAMURTHY, BENGALURU-78 (IN); Christopher LYON, Bengaluru (IN); Kelly MCDOWELL, Galveston, TX (US)

(73) Assignee: Oceaneering International, Inc., Houston, TX (US)

(21) Appl. No.: 19/648,250

(22) Filed: Apr. 15, 2026

(30) Foreign Application Priority Data
Apr. 15, 2025 (IN) 202511036257

(51) Int. Cl. G06T 5/92; G01S 15/86; G01S 15/89; G01S 15/931; G05D 1/224; G05D 1/226; G05D 1/227; G06T 5/60; G06T 7/11

(52) U.S. Cl. CPC G06T 5/92; G01S 15/86; G01S 15/89; G01S 15/931; G05D 1/2248; G05D 1/226; G05D 1/2272; G06T 5/60; G06T 7/11; G06T 2207/10016; G06T 2207/10028; G06T 2207/20084; G06T 2207/20132; G06T 2207/30252

(57) ABSTRACT

An image super-resolution may be created by using a system for image super-resolution to compare sensor telemetry obtained by a hybrid remote vehicle from a sensor against a database of images to image/audio/input data within the sensor telemetry comprising image/audio/input data and, once the image/audio/input data are identified, comparing the image/audio/input data against the secondary list of events/items that may then trigger an alert.

### CROSS-REFERENCE TO RELATED APPLICATIONS

This application claims priority through India Provisional Application 202511036257 filed on Apr. 15, 2025, incorporated herein by reference.

### BACKGROUND OF THE INVENTION

At times, there is a need to zoom in on a particular remote region of interest (ROI) via video images received from in our around that ROI, e.g., one subsea, surface, or arial. Normal methods will yield only a pixelated image.

### BRIEF DESCRIPTION OF DRAWINGS

Various figures are included herein which illustrate aspects of embodiments of the disclosed inventions.

FIG. 1 is a block diagram of an exemplary system; and

FIG. 2 is a generic flow diagram of an exemplary method.

### DETAILED DESCRIPTION OF EMBODIMENTS OF THE INVENTION

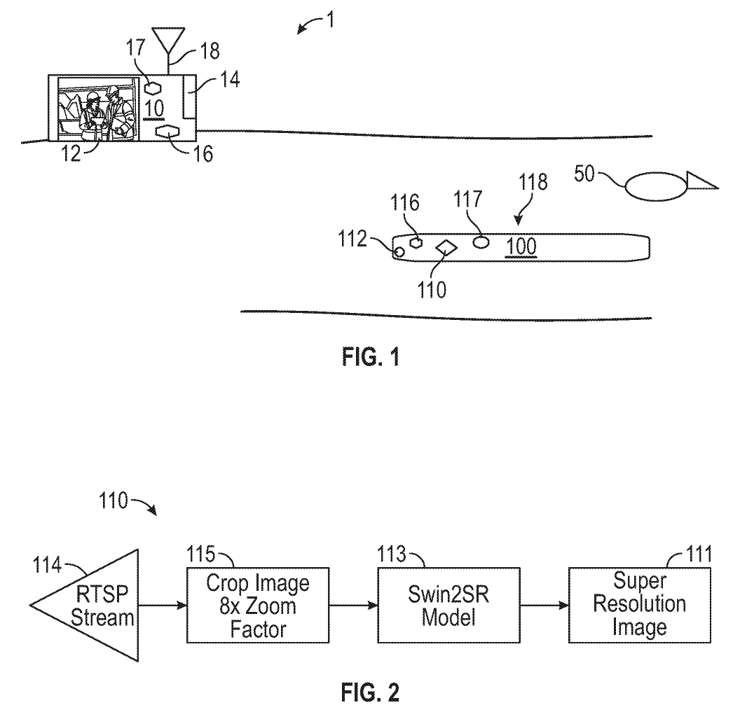

Referring generally to FIG. 1, the disclosed invention allows remote operator 12 to control one or more hybrid remote vehicles 100 (which can be subsea, surface, or aerial vehicles although discussed herein as subsea) from remote operations center 10, typically an onshore remote operations center. System for image super-resolution 1 comprises hybrid remote vehicle 100, software artificial intelligence module (AI) 110 operatively installed in hybrid remote vehicle 100 and available to or otherwise operating in, e.g., one or more processors in hybrid remote vehicle 100, where software AI 110 comprises software video image transformer 111 (FIG. 2) for image super resolution and restoration, and remote operations center 10. Communication between remote operations center 10 and hybrid remote vehicle 100 is typically using transceivers 18,118.

Hybrid remote vehicle 100 is equipped with one or more sensors 112, primarily audio and/or visual, but may also include acoustic sensors such as sonar, optical sensors such as LIDAR, or the like, or a combination thereof. Typically, hybrid remote vehicle 100 operates as an autonomous vehicle unless remote operator 12 takes manual control of hybrid remote vehicle 100.

In a first embodiment, referring generally to FIG. 2, software AI 110 is resident in hybrid remote vehicle 100 and comprises a video/audio ingestion framework called Ocean Perception Stack (OPS) which comprises a specialized software and hardware framework designed to enable autonomous vessels, subsea robots, and/or marine AI systems to interpret and navigate an aquatic environment, although such may also be used for non-subsea vehicles such as aerial vehicles. Unlike automotive stacks, an OPS typically handles high environmental variability, lack of GPS/high-bandwidth communication (in deep water), and specific sensor constraints. Software AI 110 is adapted to receive input from sensor 112, which may comprise an optical image (e.g., a video stream) comprising a cropped region of interest (“ROI”), and return a sharper, “super” resolution image back to a user, e.g., remote operator 12. Currently no solution exists which works alongside OPS for super resolution for remote operations center 10.

Typically, the software video image transformer 111 comprises AI photorealistic image super-resolution and restoration model 113, such as such as Swin2SR model 113 developed by the mv-lab research team (https://www.aimodels.fyi/creators/replicate/mv-lab), and related software which, in turn, comprises or otherwise has access to one or more large image and/or audio models in real time. In an embodiment, Swin2SR model 113 is used by software video image transformer 111.

In the operation of exemplary methods, referring back to FIG. 1, software AI 110 is operatively installed and made operative in hybrid remote vehicle 100. Software AI 110 typically comprises alert module 17,117 which is configured to alert operator 12 if hybrid remote vehicle 100 reaches its destination or has encountered object 50 of which operator 12 should be made aware, e.g., an obstruction, an animal, a piece of equipment, an acoustic beacon, a landslide, a defect, damaged equipment, or the like, or a combination thereof. Alert module 17,117 may be present in or otherwise available to remote operations center 10, hybrid remote vehicle 100, or distributed between the two.

Since operator 12 cannot watch or otherwise monitor telemetry from a fleet of hybrid remote vehicles 100 all at once, software AI 110 is operative to compare sensor telemetry obtained by hybrid remote vehicle 100 against a database of images, e.g., database 116, which is disposed within or otherwise available to hybrid remote vehicle 100, or database 16, which is disposed within or otherwise available to remote operations center 10. In embodiments, real-time streaming protocol (“RTSP”)/video cropped frames received by operator 12 are provided by the OPS to the software comprising AI, e.g., Swin2SR model 113, which then outputs a super resolution image derived from RTSP/video cropped frames 114,115 typically received from sensor 112 to hybrid remote vehicle 100, remote operations center 10, or both for further processing. An ROI may be zoomed in as required, e.g., by operator 12, e.g., using image cropper 115.

Once the image/audio/input data are identified, they may be compared against a secondary list of events/items, typically located at or available to remote operations center 10, that may then trigger an alert which may then further trigger or otherwise have one or more autonomous commands issued to hybrid remote vehicle 100 (such as all stop, wait, observe, or the like, or a combination thereof), either by operator 12, automatically, or a combination thereof. If an alert to operator 12 is triggered, then one or more displays 14 in remote operations center 10 can display the received/identified images/audio (or the like, or a combination thereof) from hybrid remote vehicle 100 with a visual and/or audio alert to operator 12 who can then take control of hybrid remote vehicle 100, ignore the alert, or issue other instructions to hybrid remote vehicle 100. Alternatively, taking control or other actions may occur automatically using systems onboard hybrid remote vehicle 100, present at remote operations center 10, or a combination thereof.

The foregoing disclosure and description of the inventions are illustrative and explanatory. Various changes in the size, shape, and materials, as well as in the details of the illustrative construction and/or an illustrative method may be made without departing from the spirit of the invention.

1. A system for image super-resolution, comprising:
a) a remote operations center;
b) a database of images;
c) a secondary list of events/items;
d) a hybrid remote vehicle comprising:
i) a sensor; and
ii) software AI operatively in communication with the database of images and the secondary list of events/items, the software AI comprising:
(1) a video/audio ingestion framework which is adapted to receive video input from the sensor; and
(2) an alert module operative to present an alert to inform an operator with access to the remote operations center if the hybrid remote vehicle has reached its destination or has encountered an object of which the operator should be made aware;
e) a software video image transformer operatively in communication with the software AI and configured to process input received from the sensor into a visual image output;
f) a transceiver operatively disposed in-between the remote operations center and the hybrid remote vehicle; and
g) a visual display disposed in the remote operations center and operatively in communication with the software AI and the software video image transformer.

2. The system for image super-resolution of claim 1 wherein the sensor comprises an audio sensor, a visual sensor, an acoustic sensor, or an optical sensor.

3. The system for image super-resolution of claim 2 wherein the acoustic sensor comprises a sonar sensor.

4. The system for image super-resolution of claim 2 wherein the optical sensor comprises a LIDAR sensor.

5. The system for image super-resolution of claim 1 wherein the software video image transformer comprises an Swin2SR model.

6. The system for image super-resolution of claim 1 wherein:
a) the video input comprises an optical image comprising a cropped region of interest (“ROI”); and
b) the visual image output comprises a super resolution image created from the ROI.

7. The system for image super-resolution of claim 1 wherein the visual image input comprises a video stream.

8. The system for image super-resolution of claim 1 wherein the software video image transformer comprises:
a) an AI photorealistic image super-resolution and restoration model; and
b) AI visual processing software which comprises or otherwise has access to a large image model or audio model in real time.

9. A method for creating image super-resolution using a system for image super-resolution, comprising a remote operations center; a database of images; a secondary list of events/items; a hybrid remote vehicle comprising a sensor and software AI operatively in communication with the database of images and the secondary list of events/items where the software AI comprises a video/audio ingestion framework which is adapted to receive video input from the sensor and an alert module operative to present an alert to inform an operator with access to the remote operations center if the hybrid remote vehicle has reached its destination or has encountered an object of which the operator should be made aware; a software video image transformer operatively in communication with the software AI and configured to process input received from the sensor into a visual image output; a transceiver operatively disposed in-between the remote operations center and the hybrid remote vehicle; and a visual display disposed in the remote operations center and operatively in communication with the software AI and the software video image transformer, the method comprising:
a) operatively installing the software AI in the hybrid remote vehicle;
b) establishing communication between the remote operations center and the hybrid remote vehicle via the transceiver;
c) using the software AI to compare sensor telemetry comprising image/audio/input data obtained by the hybrid remote vehicle from the sensor against the database of images; and
d) once the image/audio/input data are identified, comparing the image/audio/input data against the secondary list of events/items that may then trigger an alert.

10. The method of claim 9, further comprising issuing an alert to inform an operator with access to the remote operations center if the hybrid remote vehicle is determined to have reached its destination or encountered an object of which the operator should be made aware.

11. The method of claim 10, wherein the object comprises an obstruction, an animal, a piece of equipment, an acoustic beacon, a landslide, a defect, or damaged equipment.

12. The method of claim 10, further comprising issuing an autonomous command to the hybrid remote vehicle either by the operator, automatically, or a combination thereof after the receipt of the alert.

13. The method of claim 12, wherein the autonomous commands comprise a command to stop, wait, or observe.

14. The method of claim 10, wherein, if an alert to the operator is triggered, the method further comprises displaying the images or audio received or identified from the hybrid remote vehicle on the visual display.

15. The method of claim 10, wherein the alert comprises a separate visual image or audio and the method further comprises allowing the operator to take control of the hybrid remote vehicle, ignore the alert, or issue a command to the hybrid remote vehicle.

16. The method of claim 9, further comprising automatically taking an action using a system onboard the hybrid remote vehicle or present at the remote operations center.

17. The method of claim 9, further comprising:
a) using the software AI to provide real-time streaming protocol (“RTSP”)/video cropped frames received by the operator to a second software AI;
b) outputting a super resolution image derived from the RTSP/video cropped frames to the hybrid remote vehicle, the remote operations center, or both the hybrid remote vehicle and the remote operations center for further processing.

18. The method of claim 17, wherein the second software AI comprises an Swin2SR model.

19. The method of claim 9, further comprising allowing the operator to zoom in on an ROI.

20. The method of claim 9, wherein the hybrid remote vehicle operates as an autonomous vehicle unless the remote operator takes manual control of the hybrid remote vehicle.
